(19) United States
(12) Patent Application Publication
(10) Pub. No.: US 2004/0206580 A1
(43) Pub. Date: Oct. 21, 2004

(54) Machine-room-less elevator

(76) Inventors: Takashi Ishii, Matsudo-Shi (JP); Hiroshi Sano, Fuchu-Shi (JP); Kan Kawasaki, Mitaka-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,510

(22) PCT Filed: Jun. 13, 2003
(86) PCT No.: PCT/JP03/07573

(30) Foreign Application Priority Data
Jun. 14, 2002 (JP) 2002-175024

(51) Int. Cl. B66B 11/08

(52) U.S. Cl. 187/264; 187/266; 187/254

(57) ABSTRACT

An elevator in which a dimension of an elevator shaft does not need to be increased when enlarging a hoist, and a position where a cage is suspended by a hoist cable can be flexibly selected. In an elevator according to the present invention, a hoist 10 is disposed such that a rotational axis thereof is vertically extended. Thus, when an axial dimension of the hoist 10 is increased to enlarge the hoist 10, a dimension of an elevator shaft does not need to be increased. Since a driving shaft 10a of the hoist 10 is vertically extended, an area occupied by the hoist is remarkably reduced when viewed in a horizontal cross-sectional view of the elevator shaft. Thus, the freedom to dispose the hoist 10 is enhanced so that a position where a cage 3 is suspended by a hoist cable 14 can be flexibly selected.

### BACKGROUND OF THE INVENTION

1. Field of the Invention

The present invention relates to a machineroom-less elevator having no machineroom disposed above an elevator shaft provided in a building.

2. Description of the Related Art

Various machineroom-less elevators having no machineroom disposed above an elevator shaft have been developed and proposed for efficiently utilizing spaces in buildings and for observing regulations regarding the right to sunlight.

An example of such an elevator features a hoist disposed in a gap between a space required for a cage to vertically move in an elevator shaft including the vertically extending portion of the space (hereinafter referred to as “moving space”) and an inner wall surface of the elevator shaft.

For example, in a conventional machineroom-less elevator shown in FIG. 9, a cage 3 is adapted to vertically move while guided by a pair of right and left cage-side guide rails 2L and 2R disposed in an elevator shaft 1. A counterweight 5 is adapted to vertically move while guided by a pair of front and rear counterweight-side guide rails 4f and 4r.

A disc-shaped hoist 6 attached on a right inner wall surface 1a in a top portion of the elevator shaft 1 has a horizontal driving shaft extending in the right and left direction. Thus, a traction sheave 7 rotates around a rotational axis horizontally extending in the right and left direction.

A hoist cable 8 wound around the traction sheave 7 has a portion 8a downwardly extending to the cage 3. The portion 8a is wound around a pair of right and left below-cage sheaves 3a and 3b provided below the cage 1, and then extends upward to suspend the cage 3 in a so-called two-to-one roping arrangement, with a tip 8b thereof being fixed to a top of the elevator shaft 1 by a hitching device (not shown).

Similarly, the hoist cable 8 wound around the traction sheave 7 has a portion 8c downwardly extending to the counterweight 5. The portion 8c is wound around a counterweight-side sheave 5a provided above the counterweight 5, and then extending upwardly to suspend the counterweight 5 in the two-to-one roping arrangement, with a tip 8d thereof being fixed to a top of the elevator shaft 1 by a hitching device (not shown).

In a conventional machineroom-less elevator shown in FIG. 9, when the hoist 6 is enlarged in response to an increase of a weight of the cage 3, an increased axial dimension of the hoist 6 makes the traction sheave 7 come close to the cage 1. Thus, a right and left direction dimension “W” of the elevator shaft 1 must be widened, provided that the dimension of the cage 1 is set at a specified value.

A position in which the cage 3 is suspended by the hoist cable 8 in the elevator shaft 1 is determined by a diameter of the hoist 6 and a distance in the back and forth direction between a pair of front and rear counterweight-side guide rails 4f and 4r. Thus, when a diameter of the hoist 6 is increased in connection with an enlargement thereof, a position in which the cage 3 is suspended by the hoist cable 8 is limited.

### SUMMARY OF THE INVENTION

It is an object of the present invention to provide a machineroom-less elevator in which the above-mentioned disadvantages in the prior art can be solved, namely a machineroom-less elevator which requires no dimensional increase of an elevator shaft upon enlargement of a hoist, and it is possible to flexibly select a position in which a cage is suspended by a hoist cable.

According to a first aspect of the present invention, a machineroom-less elevator comprises:

a cage adapted to vertically move in an elevator shaft;

a hoist disposed in the elevator shaft which generates a driving force to vertically move the cage, and has a traction sheave with a sheave surface thereof horizontally positioned;

a counterweight which is disposed on a side of one of the side surfaces of said cage, and is spaced apart from said cage; and

a hoist cable suspended by said hoist, with one end thereof guided to a side of said cage and the other end thereof guided to a side of said counterweight.

In a machineroom-less elevator according to the first aspect of the present invention, the traction sheave is disposed so that its end surface extends horizontally, in other words, a driving shaft of the hoist is disposed to extend vertically. Therefore, a dimension of the elevator shaft requires no increase even when the axial dimension of the hoist becomes large upon enlargement of the hoist.

Since the driving shaft of the hoist extending vertically, the area occupied by the hoist is remarkably reduced when viewed in a horizontal cross-sectional view of the elevator shaft. Thus, the freedom to dispose the hoist is enhanced, a position in which the cage is suspended by the hoist cable can be flexibly selected.

In a machineroom-less elevator according to a second aspect of the present invention, a pair of guide sheaves rotating around a horizontal rotational axis can be provided to guide the hoist cable extending from the traction sheave.

That is, with a pair of guide sheaves provided on a cage-side and a counterweight-side, the hoist and the traction sheave can be integrated with each other such that the traction sheave rotates around a vertical axis. Thus, the areas occupied by the hoist and the traction sheave can be reduced when viewed in a horizontal cross-sectional view of an elevator shaft.

A position in which the cage is suspended by the hoist cable can be flexibly selected by changing the positions of the cage-side guide sheave and the counterweight-side guide sheave.

In a machineroom-less elevator according to a third aspect of the present invention, a traction sheave can be disposed to rotate around a horizontal axis, and a driving force transmitting device for transmitting a driving force of the hoist having a vertically extending drive shaft to the traction sheave can be provided.

Since the traction sheave rotates around a horizontal axis while the hoist has a vertically extending drive shaft, a hoist cable can be disposed as usual.

A traction sheave can be disposed in a desired position by changing a shape and dimension of the driving force transmitting device. Thus, a position in which the cage is suspended by the hoist cable can be flexibly selected.

### BRIEF DESCRIPTION OF THE DRAWINGS

FIG. 1 is a perspective view of a machineroom-less elevator according to a first embodiment of the present invention;

FIG. 2 is a plan view of the machineroom-less elevator in FIG. 1 with an elevator shaft;

FIG. 3 is a front view of the machineroom-less elevator in FIG. 1;

FIG. 4 is a right side view of the machineroom-less elevator shown in FIG. 1;

FIG. 5 is a plan view of a first variation of the machineroom-less elevator in FIG. 1;

FIG. 6 is a right side view of a second variation of the machineroom-less elevator in FIG. 1;

FIG. 7 is a right side view of a second variation of the machineroom-less elevator in FIG. 1;

FIG. 8 is a perspective view of a machineroom-less elevator according to a first embodiment of the present invention; and

FIG. 9 is a plan view of a conventional machineroom-less elevator with an elevator shaft.

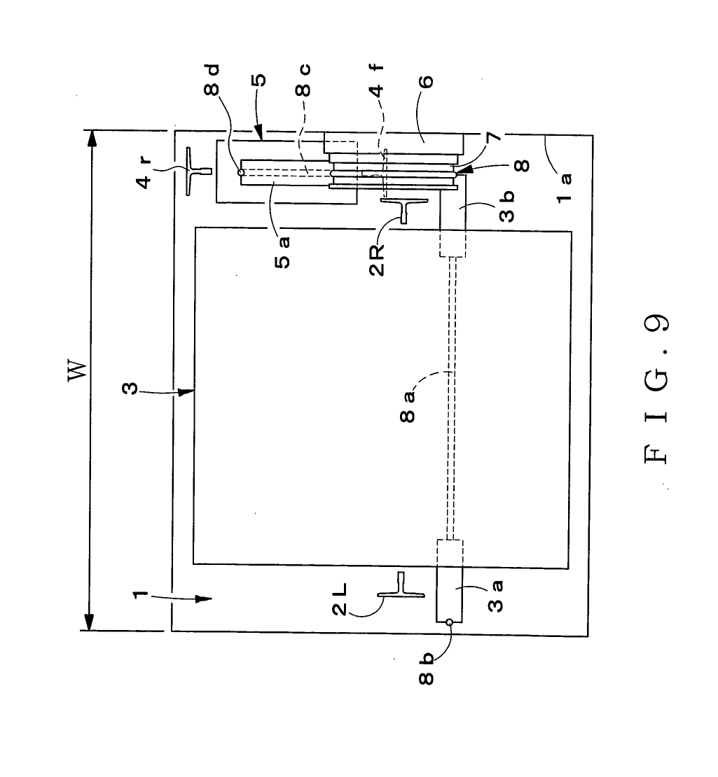

### DESCRIPTION OF THE PREFERRED EMBODIMENTS

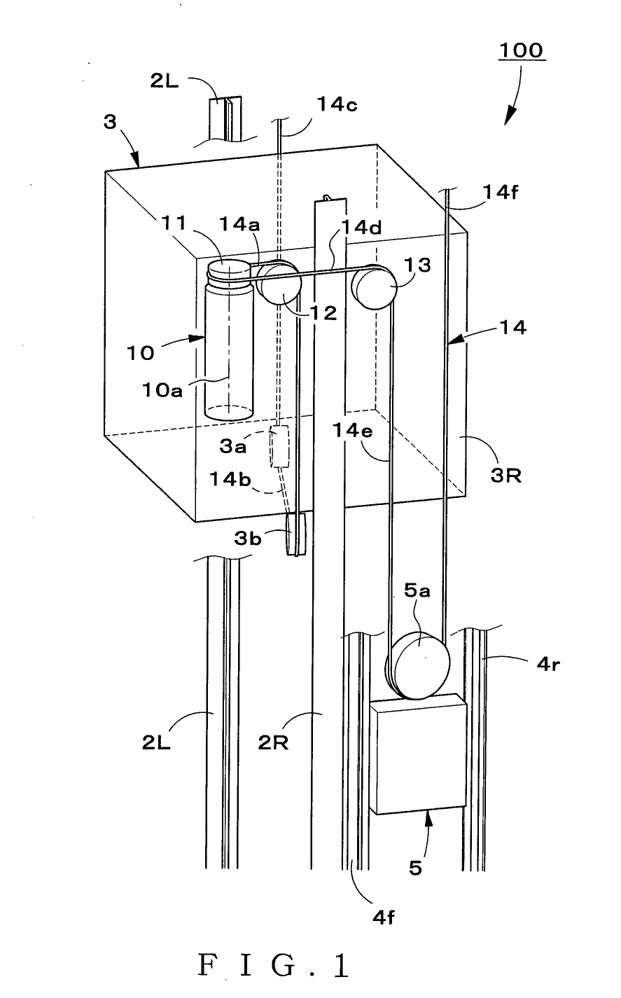

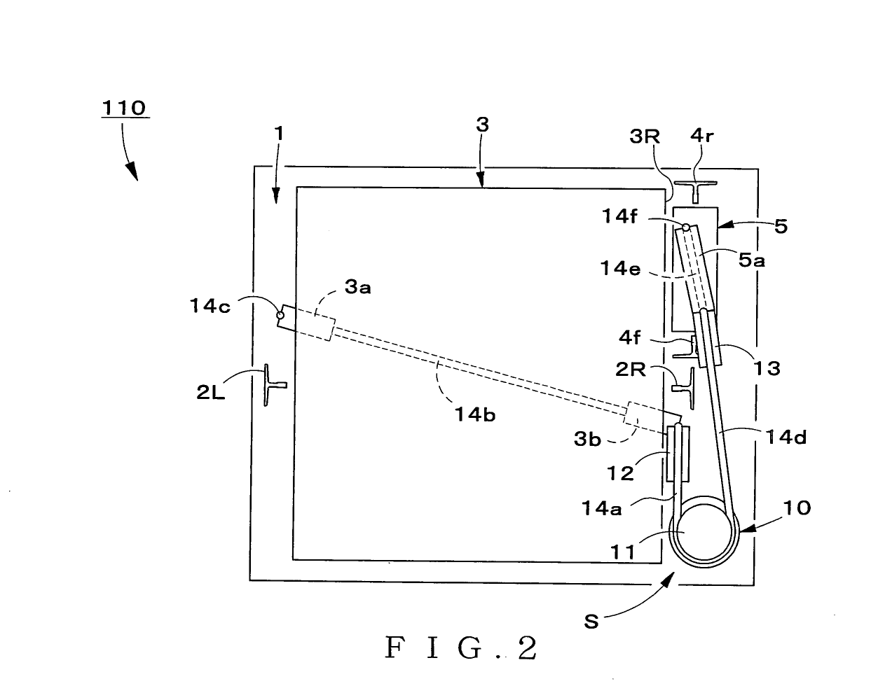

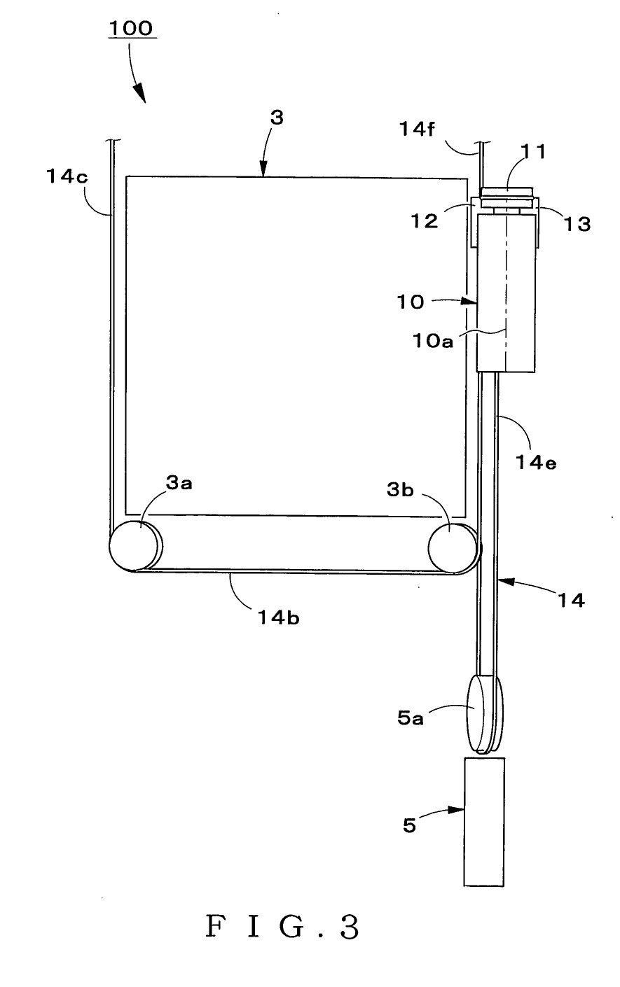

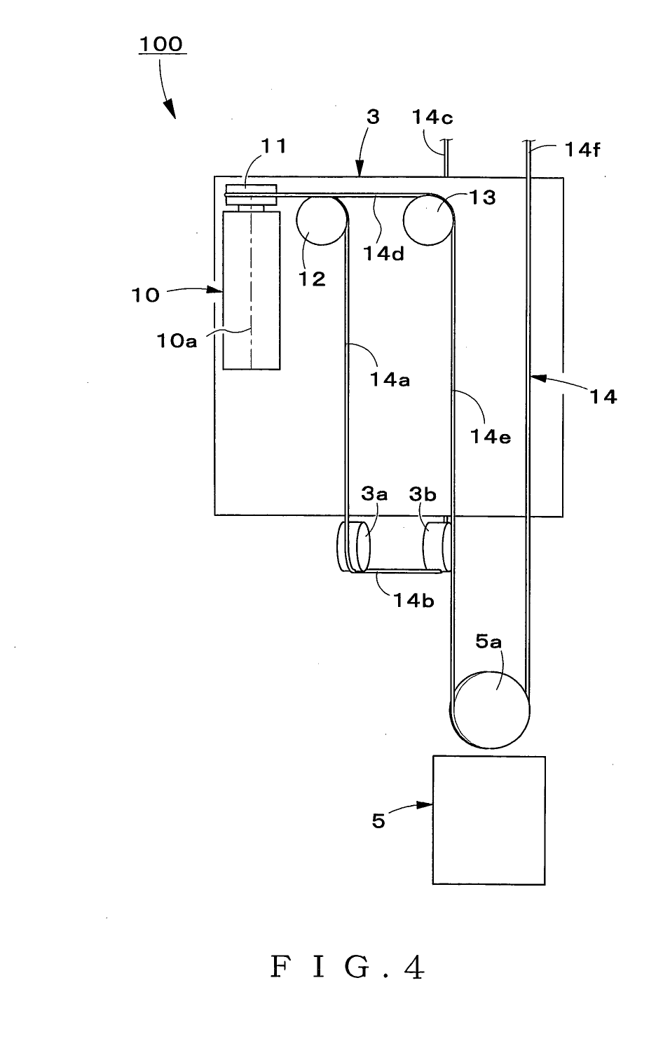

Embodiments of a machineroom-less elevator according to the present invention will be described below with reference to FIGS. 1 to 8.

In the description below, the right and left direction is defined as the direction in which an entrance door of a cage is opened/closed, the back and forth direction is defined as the direction in which passengers enter/exit the cage, and the up and down direction is defined as the vertical direction, respectively.

The identical components are represented by the same reference numerals, and a detailed description thereof is omitted.

First Embodiment

A machineroom-less elevator 100 of a first embodiment is described with reference to FIGS. 1 to 4. A cage 3 is adapted to vertically move while guided by a pair of right and left cage-side guide rails 2L and 2R disposed in an elevator shaft 1. A counterweight 5 is adapted to vertically move while guided by a pair of front and rear counter-weight guide rails 4f and 4r disposed on a side of a right side surface 3R of the cage 3.

Above the elevator shaft 1, there are arranged a cylinder-shaped hoist 10 having a vertical driving shaft, and a traction sheave 11 which is driven by the hoist 10 to rotate around a coaxial axis of the hoist 10. An upper end surface of the traction sheave 11 extends horizontally in the elevator shaft 1, being opposed to a ceiling surface of the elevator shaft. A dimension of the outer diameter of the hoist 10 and that of the traction sheave 11 are substantially the same.

In the elevator shaft 1, the hoist 10 and the traction sheave 11 are disposed inside a gap “S” between a space required for a cage to move vertically in the elevator shaft 1 including vertically extending portion of the space (hereinafter referred to as “moving space”) and a right inner wall surface 1a of the elevator shaft 1.

The hoist 10 can be fixed to an inner wall surface of the elevator shaft 1, or can be supported by the cage-side guide rail 2R and the counterweight-side guide rails 4f and 4r.

A cage-side guide sheave (a second guide sheave) 12 is provided between the traction sheave 11 and the right cage-side guide rail 2R, which is rotatable around a horizontal axis in the right and left direction. A counterweight-side guide sheave (a first guide sheave) 13 is provided at the rear of the right cage-side guide rail 2R, which is rotatable around a horizontal axis in a slightly inclined manner with respect to the right and left direction. The cage-side guide sheave 12 and the counterweight-side guide sheave 13 are disposed such that they are positioned substantially inside a contour line of the traction sheave 11 when viewed from the back and forth direction.

The cage-side guide sheave 12 and the counterweight-side guide sheave 13 may be rotatably supported by brackets fixed to the cage-side guide rail 2R and the counterweight-side guide rails 4f and 4r, respectively.

A hoist cable 14 wound around the traction sheave 11 has a portion 14a that extends horizontally rearward toward the cage 3. The portion 14a is wound around a cage-side guide sheave 12 and is then extended downward. After horizontally extended (14b) between a pair of right and left below-cage sheaves 3a and 3b, the portion 14a is extended upward to suspend the cage 3 in the two-to-one roping arrangement, with a tip 14c thereof being fixed to a top of the elevator shaft 1 by a hitching device (not shown).

Preferably, the portion 14b of the hoist cable 14 that horizontally extends below the cage 3 is so disposed as to pass below the center of gravity of the cage 3 when viewed vertically.

The hoist cable 14 wound around the traction sheave 11 has a portion 14d which horizontally extends rearward toward a side of the counterweight 5 on a side of the right inner wall surface 1a of the elevator shaft 1. The portion 14d is wound around the counterweight-side guide sheave 13 and is then extended downward (14e). After being wound around a counterweight-side sheave 5a, the portion 14d is extended upward to suspend the counterweight 5 in the two-to-one roping arrangement, with a tip 14f thereof being fixed to a top of the elevator shaft 1 by a hitching device (not shown).

That is, in the machineroom-less elevator 100 of the first embodiment, since a driving shaft of the hoist 10 is vertically extended, a dimension of the elevator shaft 1 does not need to be increased when an axial length of the hoist 10 is vertically elongated to enlarge the hoist 10.

Since the driving shaft 10a of the hoist 10 is vertically extended, an area occupied by the hoist 10 is remarkably reduced when viewed in a horizontal cross-sectional view of the elevator shaft 1. Thus, the freedom to dispose the hoist 10 in the elevator shaft 1 is enhanced so that a position where the cage 3 is suspended by the hoist cable 14 can be flexibly selected.

By providing the cage-side guide sheave 12 and the counterweight-side guide sheave 13 which are rotatable around a horizontal axis, the traction sheave 11 can be rotated around a vertical axis. Therefore, the hoist 10 and the traction sheave 11 are coaxially integrated so that spaces occupied by them in the elevator shaft 1 can be reduced.

A position where the cage 3 is suspended by the hoist cable 14 can be flexibly selected by selecting positions where the cage-side guide sheave 12 and the counterweight-side guide sheave 13 are disposed.

The counterweight-side guide sheave 13 is positioned close to the right side surface 3R of the cage 3, which enlarges a winding angle of the hoist cable 14 with respect to the traction sheave 11 so that a frictional force therebetween can be increased.

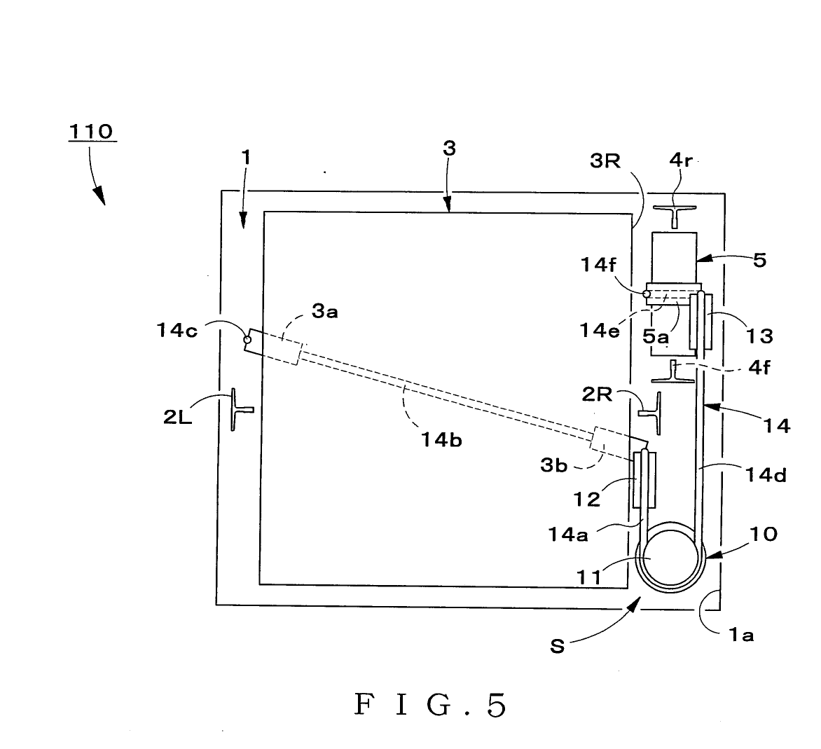

A first variation of the machineroom-less elevator 100 of the first embodiment is described below with reference to FIG. 5.

In a machineroom-less elevator 110 of the first variation, a position of a counterweight-side guide sheave 13 is changed to be in a close relation with a right inner wall surface 1a of an elevator shaft 1, with a rotational axis of the counterweight-side guide sheave 13 extending in the right and left direction. A counterweight-side sheave 5a provided on a counterweight 5 is so disposed that a rotational axis thereof extends in the back and forth direction.

In such a constitution, a position where the counterweight 5 is suspended by a hoist cable 14 can be flexibly selected inside a gap S between an elevator space and the right inner wall surface 1a of the elevator shaft 1.

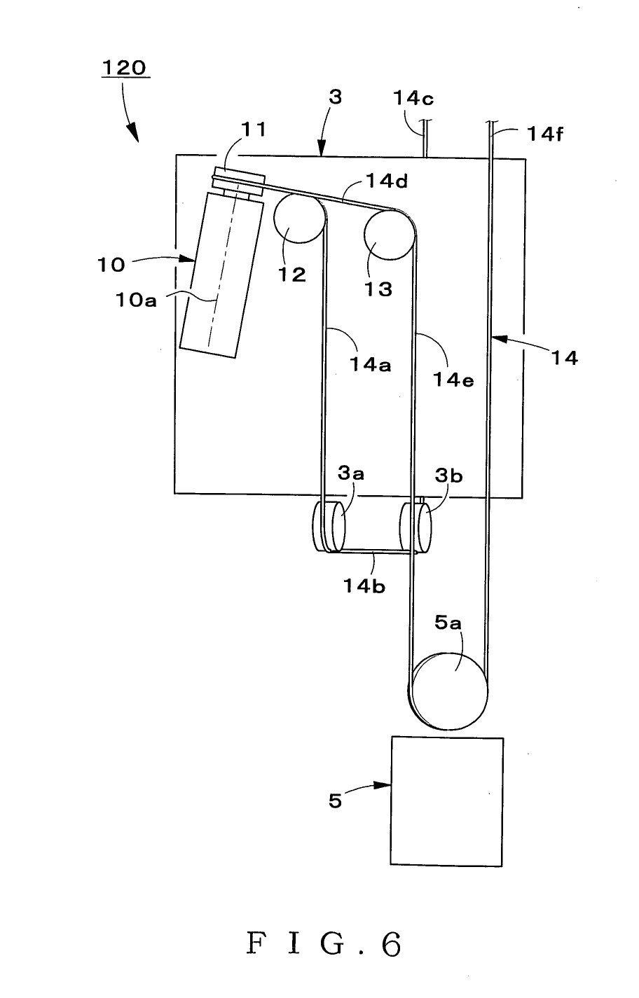

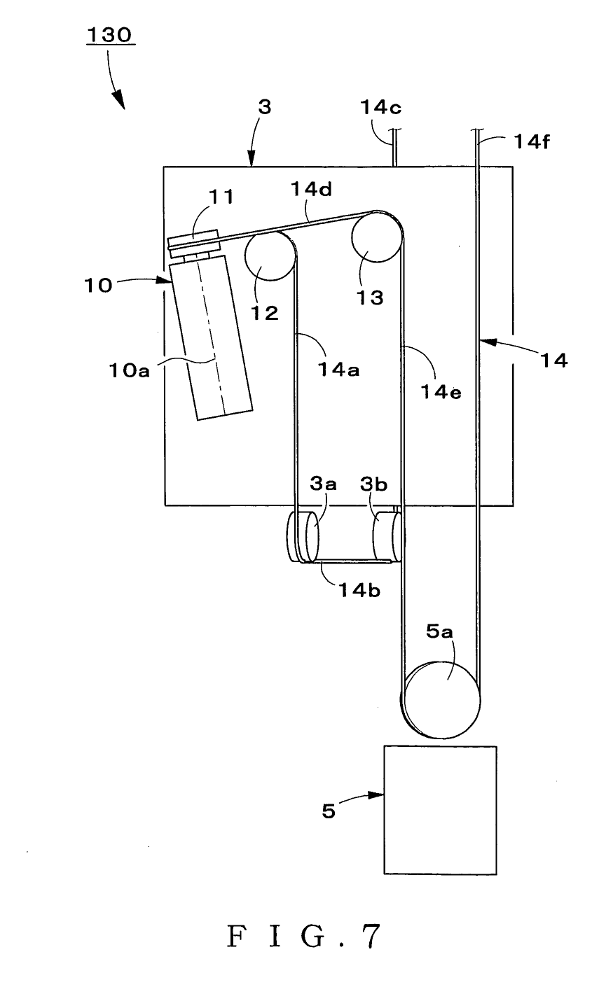

Second and third variations of the machineroom-less elevator 100 of the first embodiment are described below with reference to FIGS. 6 and 7, respectively.

In a machineroom-less elevator 120 of the second variation shown in FIG. 6, a driving shaft 10a of a hoist 10 is extended in the up and down direction, while it is inclined with respect to the vertical direction so that a traction sheave 11 is directed rearward.

On the other hand, in a machineroom-less elevator 130 of the third variation shown in FIG. 7, a driving shaft 10a of a hoist 10 is extended in the up and down direction, while it is inclined with respect to the vertical direction so that a traction sheave 11 is directed forward.

In such a constitution, vertical positions of the hoist 10, the traction sheave 11, a cage-side guide sheave 12, and a counterweight-side guide sheave 13 can be flexibly selected.

By suitably selecting an inclination angle of the driving shaft 10a of the hoist 10, the traction sheave 11 may be so arranged that an upper surface thereof is positioned below an upper end of the cage-side guide sheave 12 or the counterweight-side sheave 13.

Second Embodiment

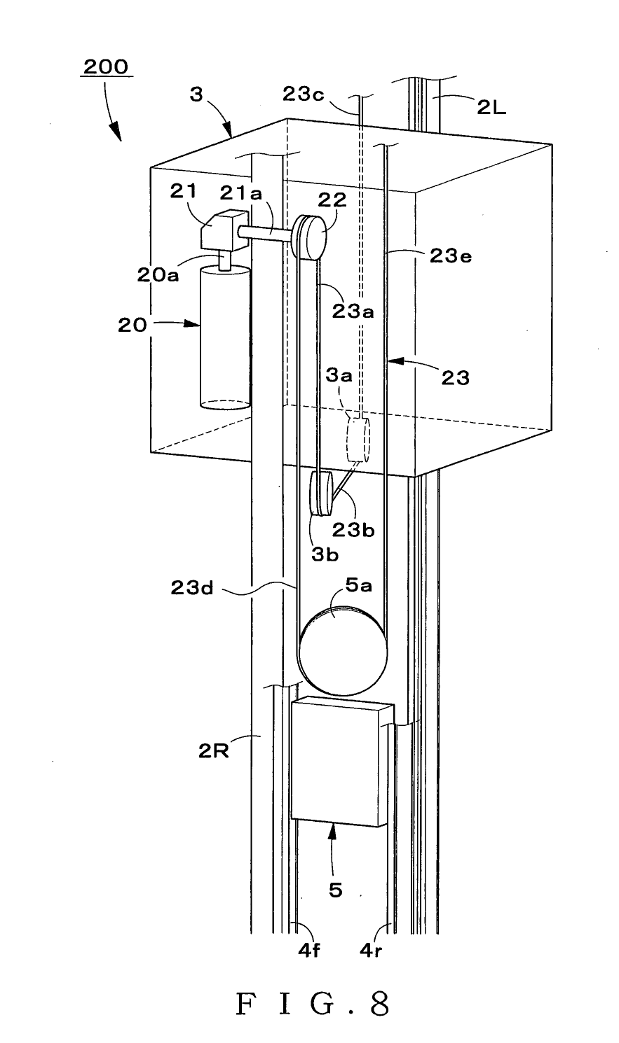

A machineroom-less elevator 200 of a second embodiment is described with reference to FIG. 8.

In the machineroom-less elevator 200 of the second embodiment, a traction sheave and a hoist cable are differently positioned, as compared with the machineroom-less elevator 100 of the first embodiment

A hoist 20 is secured to a right cage-side guide rail 2R, with its rotational axis 20a vertically extending. The hoist 20 is connected to a traction sheave 22 through a driving force transmitting device 21.

The driving force transmitting device 21 incorporates therein a pair of helical tooth gears which are meshed with each other, with a driving force transmitting shaft 21a thereof extending rearward in a horizontal direction.

The traction sheave 22 is rotationally driven by the hoist 20 through the driving force transmitting device 21 to rotate around a horizontal axis in the back and forth direction.

A hoist cable 23 wound around the traction sheave 22 has a portion 23a which extends downward to a side of a cage 3. After being horizontally extended (23b) between a pair of right and left below-cage sheaves 3a and 3b, the portion 23a is extended upward, with a tip 14c thereof being fixed to a top of an elevator shaft 1 by a hitching device (not shown).

A portion 23d which extends downward from the traction sheave 22 to a side of a counterweight 5 is wound around a counterweight-side sheave 5a and is then extended upward, with a tip 23e thereof being fixed to a top of the elevator shaft 1 by a hitching device (not shown).

That is, in the machineroom-less elevator 200 of the first embodiment, since a driving shaft of the hoist 20 is vertically extended, a dimension of the elevator shaft 1 does not need to be increased when an axial length of the hoist 20 is elongated to enlarge the hoist 20.

The traction sheave 22 can be disposed on an optimal position by changing a shape and dimension of a driving force transmitting device 21, especially changing a length of a driving force transmitting shaft 21a. Thus, a position where a cage 3 is suspended by the hoist cable 23 can be flexibly selected.

While the embodiments of the machineroom-less elevator according to the present invention have been described in detail, it should be clearly understood that the present invention is not limited thereto, and various changes and modifications are possible.

For example, although a cage-side sheave is disposed below a cage in the above-described embodiments, the cage-side sheave may be disposed above the cage.

A hoist is secured to a sidewall of an elevator shaft or a cage-side guide rail. However, the hoist may be secured to a counterweight-side guide rail.

That is, in the machineroom-less elevator according to the present invention, since a driving shaft of a hoist is vertically extended, a dimension of the elevator shaft does not need to be increased when an axial length of the hoist is elongated to enlarge the hoist.

Since the driving shaft of the hoist is vertically extended, an area occupied by the hoist is remarkably reduced when viewed in a horizontal cross-sectional view of the elevator shaft. Thus, a degree of freedom of a position where the hoist is disposed in the elevator shaft is enhanced so that a position where the cage is suspended by the hoist cable can be flexibly selected.

1. A machineroom-less elevator comprising:
a cage adapted to vertically move in an elevator shaft;
a hoist disposed in the elevator shaft which generates a driving force to vertically move the cage, and has a traction sheave with a sheave surface thereof horizontally positioned;
a counterweight which is disposed on a side of one of the side surfaces of said cage, and is spaced apart from said cage; and
a hoist cable suspended by said hoist, with one end thereof guided to a side of said cage and the other end thereof guided to a side of said counterweight.

2. A machineroom-less elevator according to claim 1, wherein
said hoist is disposed in an elevator space and said elevator shaft where said cage vertically moves, and between a space extended from the elevator space and a wall of the elevator shaft.

3. A machineroom-less elevator according to claim 1, wherein
a cage-side sheave is provided above or below said cage.

4. A machineroom-less elevator according to claim 1, wherein
said hoist has an elongated shape in its axial direction.

5. A machineroom-less elevator according to claim 1, wherein
a driving shaft of said hoist is parallel to the moving direction or the vertical direction of said cage or said counterweight.

6. A machineroom-less elevator according to claim 1, wherein
a counterweight guide rail is provided for guiding a vertical movement of said counterweight, and
at least two guide sheaves are provided adjacent the top of the counterweight guide rail.

7. A machineroom-less elevator according to claim 6, wherein
each of the rotational axes of the guide sheaves are substantially in the same direction.

8. A machineroom-less elevator according to claim 6, wherein
each of the rotational surfaces of the guide sheaves are substantially parallel to each other.

9. A machineroom-less elevator according to claim 6, wherein
the guide sheave includes a first guide sheave around which said hoist cable guided from the counterweight side is suspended, and a second guide sheave around which said hoist cable guided from the cage side is suspended, and
said traction sheave is positioned such that said hoist cable is suspended from the first guide sheave to the second guide sheave.

10. A machineroom-less elevator according to claim 6, wherein
a rotational surface of the pulley and a rotational surface of the traction sheave are disposed to be normal to each other.

11. A machineroom-less elevator according to claim 1, wherein
a counterweight-side sheave is provided above said counterweight around which said hoist cable from the first guide sheave is suspended, with a rotational surface of the counterweight sheave being positioned non-parallel with a surface of said counterweight which is opposed to said cage.

12. A machineroom-less elevator according to claim 1, wherein
a size of a cross section of said traction sheave is substantially correspondent to a thickness of said counterweight.

13. A machineroom-less elevator according to claim 6, wherein
the guide sheave is disposed to be substantially correspondent to a size of the cross section of said traction sheave.

14. A machineroom-less elevator according to claim 1 or 2, wherein
said counterweight and said hoist are provided on the same side of a side surface of said cage.

15. A machineroom-less elevator according to claim 1, wherein
an outer diameter of said hoist is substantially correspondent to an outer diameter of said traction sheave.

16. A machineroom-less elevator according to claim 1, wherein
said hoist is directly or indirectly supported by any one of a wall of the elevator shaft, the counterweight guide rail for guiding a vertical movement of said counterweight, or the cage guide rail for guiding a vertical movement of said cage.

17. A machineroom-less elevator according to claim 1, wherein
an end surface of the traction sheave is disposed to oppose to a ceiling surface of said elevator shaft.

18. A machineroom-less elevator according to claim 1, wherein
a surface height of said traction sheave is positioned lower than an upper end of the guide sheave.
